(19) United States
(12) Patent Application Publication
(10) Pub. No.: US 2007/0174266 A1
(43) Pub. Date: Jul. 26, 2007

(54) Method of optimization of listed result of internet-based search and system based on the method

(75) Inventor: Chung-Hung Hsu, Taichung City (TW)

Correspondence Address: BACON & THOMAS, PLLC, 625 SLATERS LANE, FOURTH FLOOR, ALEXANDRIA, VA, 22314, US

(73) Assignee: GU TA INTERNET INFORMATION CO., LTD., TAICHUNG CITY (TW)

(21) Appl. No.: 11/511,291

(22) Filed: Aug. 29, 2006

(30) Foreign Application Priority Data
Jan. 25, 2006 (TW) 95102898

(51) Int. Cl. G06F 17/30

(52) U.S. Cl. 707/4

(57) ABSTRACT

A method of optimization of a listed result of internet-based search includes the steps of generating a list based on the search result on Internet, ranking the list in view of a predetermined condition to generate a sub-list, and displaying the list and the sub-list on a web page, whereby the user not only can learn the result from the conventional search website after inputting a keyword, but also get relevant information to the keyword to source desired information more easily, improving the drawback of prior art. A system based on the method is accomplished by a client and a server.

### BACKGROUND OF THE INVENTION

1. Field of the Invention

The present invention relates generally to internet-based search technology for linking of web pages, and more particularly, to a method of optimization of a listed result of internet-based search in a specific ranking and a system based the method.

2. Description of the Related Art

Referring to FIG. 4, while searching in an internet search website, like Yahoo! or Google, a user can input a desired keyword or keywords, like “valve”, on one web page 91 and then the search engine at the server compares the keyword “valve” with its huge database to rank the relevant uniform resource locators (URLs) to “valve” according to levels of similarity and to list them on another web page 95 one by one, page by page.

The listed outcome of the above-mentioned search method is defective because the listed URLs are shown page by page but most of the users read the first page only and other users who have more time may read more pages. Thus, the URLs with extremely low rankings are hardly read but might be what the users desire most.

In view of the aforementioned drawback, the present invention provides an additional classification of URLs to allow the user to more easily seek the information that matches the user's desire.

### SUMMARY OF THE INVENTION

The primary objective of the present invention is to provide a method of optimization of a listed result of internet-based search and a system based the method, which not only lists the search result but also provides an arranged sub-list in synchronization to allow the users to source their desired information more easily.

The foregoing objective of the present invention is attained by the method and the system. The method includes the steps of inputting a keyword or keywords on one web page, wherein the web page is linked to a searchable database having information at least having numerous URLs; searching and comparing information of the database with the keyword or keywords in view of a first predetermined condition and then ranking the matched information in view of a second predetermined condition to generate a list; ranking the list in view of a third predetermined condition and picking the prior items ranked in the list to generate a sub-list; and displaying the list and the sub-list on a web page.

The system includes a client and a server. The client has an input device and a display device for the user's input and view respectively. The server is a computer system, having a searchable database and a keyword comparing module. The database has a large number of URLs. The client and the server are connected through Internet. After the user inputs a keyword or keywords at the client, a request for search of the keyword or keywords is sent to the server. After receiving the request, the server compares the information of the database with the keyword or keywords in view of the first predetermined condition. After matched information is located in the database, the server ranks the matched information in view of the second predetermined condition to generate a list. The server picks prior items ranked in the list in view of the third predetermined condition to generate a sub-list and then transmits the list and the sub-list to the client. After receiving the list and the sub-list, the client displays them on the display device.

### BRIEF DESCRIPTION OF THE DRAWINGS

FIG. 1 is a block diagram of the steps of a preferred embodiment of the present invention.

FIG. 2 illustrates the framework of the method based on the preferred embodiment of the present invention.

FIG. 3 illustrates the framework of the system based on the preferred embodiment of the present invention.

FIG. 4 illustrates the framework of the prior art.

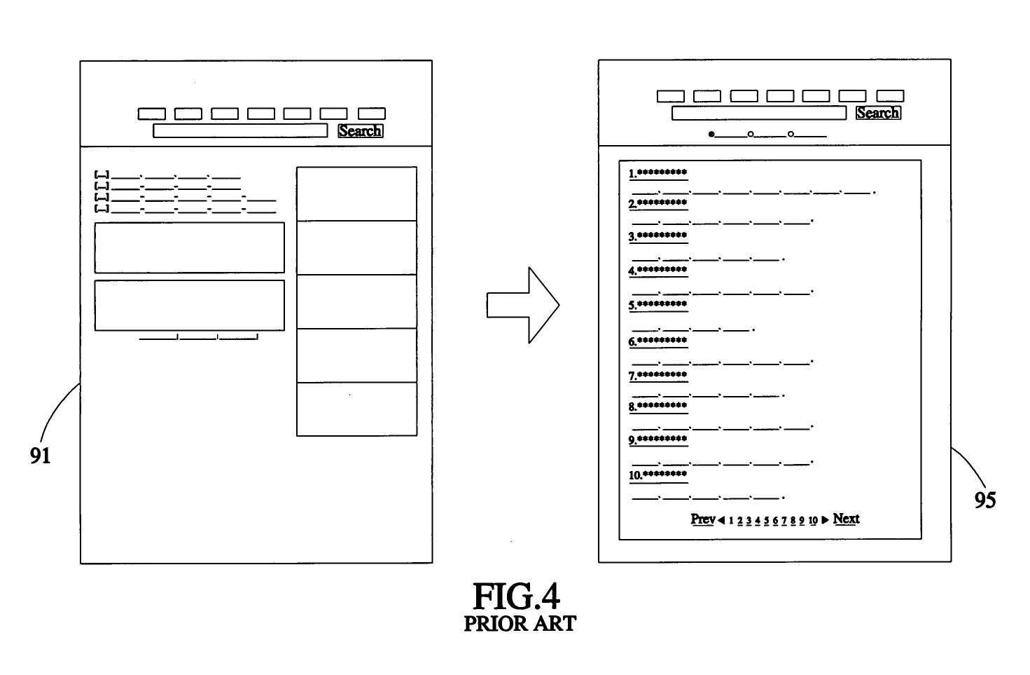

### DETAILED DESCRIPTION OF PREFERRED EMBODIMENTS

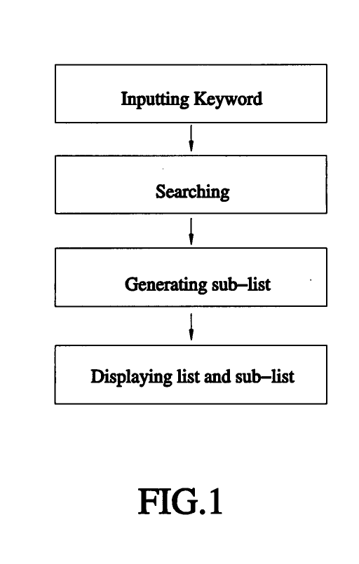

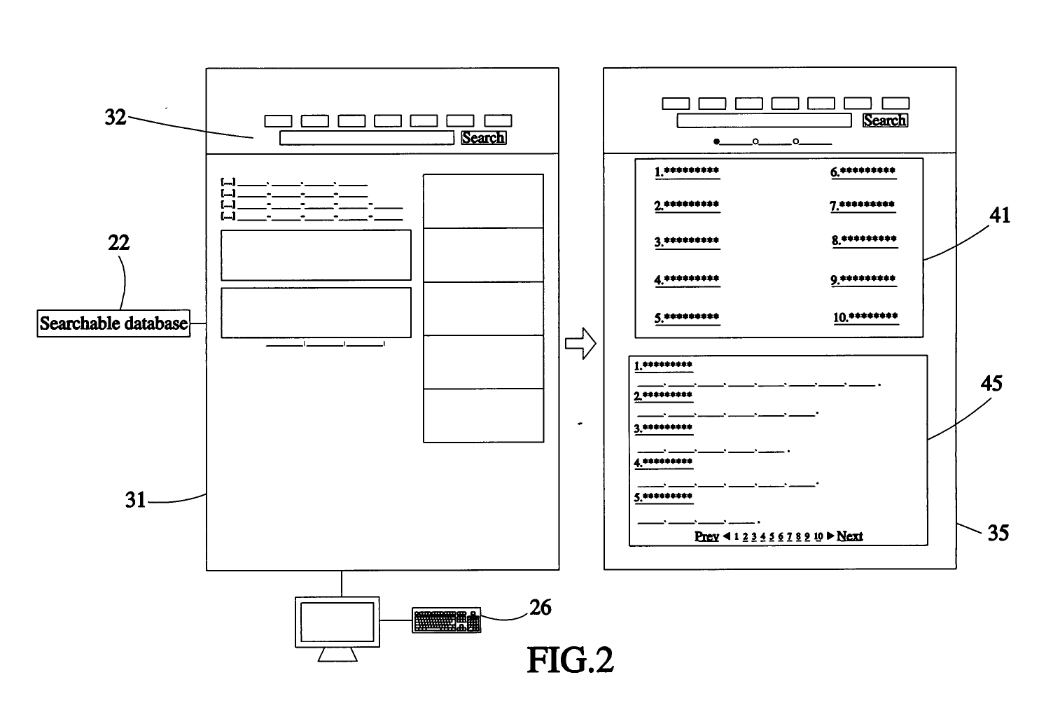

Referring to FIGS. 1-2, a method of optimization of a listed result of internet-based search, based on a preferred embodiment of the present invention, includes the following steps.

A. Inputting Keyword

Input a keyword or keywords, like “valve”, on one webpage 31 capable of searching on Internet. The web page 31 is linked to a searchable database 22, having a search column 32 for the user's input of the keyword or keywords through a keyboard 26 of a computer system. The database 22 at least contains a large number of URLs as well as numerous product names, numerous industry categories, and numerous classified links of collective product names that correspond to the URLs respectively.

B. Searching and Comparing

Search and compare information of the database 22 with the keyword or keywords in view of a first predetermined condition and then ranking matched information located in the database in view of a second predetermined condition to generate a list 41. The first predetermined condition contains levels of similarity between characters of the keyword and those of the product named or industry categories, e.g. the level of similarity reaches 80% and above. The second predetermined condition contains the levels of similarity between classified links of collective product names, the levels of similarity between product names on web sites, user click rates, amount of payment, or user's browsing duration.

C. Generating Sub-List

Rank the information of the list 41 in view of a third predetermined condition and pick prior items ranked in the list 41 to generate a sub-list 45. The third predetermined condition contains levels of similarity for classified links of collective product names, product names on websites, product categories, and business categories, user click rates, amount of payment, or user's browsing duration. In this embodiment, the sub-list 45 can be ranked by levels of the similarity between the keyword “valve” and the product categories, like ball valve, safety valve, pneumatic valve, hydraulic valve, or control valve.

D. Displaying List and Sub-List

Display the list 41 and the sub-list 45 on another web page 35. The list 41 and the sub-list 45 are shown with text hyperlinks, wherein the sub-list 45 is located above the list 41. In this embodiment, the list 41 contains the relevant hyperlinks matching the keyword “valve” and the sub-list 45 contains the relevant hyperlinks of various industry categories matching the keyword “valve”.

In light of the above steps, the user not only can learn the result of the conventional search web site from the list 41 after inputting a keyword or keywords but also learn the relevant information of the industry categories to the keyword or keywords from the sub-list 45. The third predetermined condition defined as the industry categories relevant to the keyword is for example in this embodiment only but not to limit the scope of claim of the present invention. Alternatively, the third predetermined condition can be other ranking condition for generating the sub-list 45 to further provide the user with an arranged result, enabling the users to find their desired information more easily.

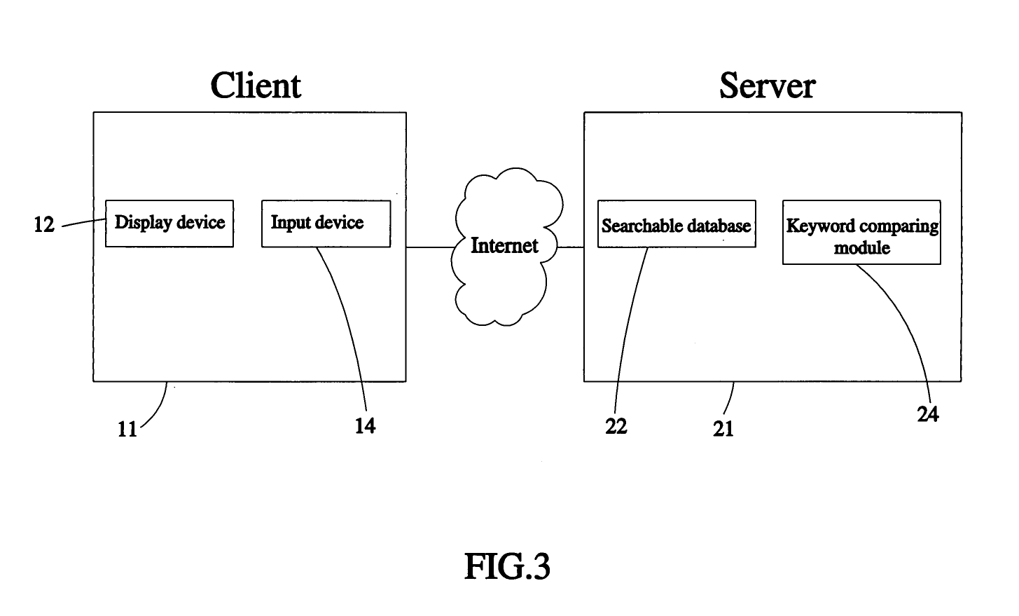

Referring to FIG. 3 in view of FIG. 2, a system based on the aforementioned method includes a client 11 and a server 21.

The client 11 is a computer system, having an input device 14, such as a keyboard, and a display device, such as a display screen, for the user's input and view respectively.

The server 21 is a computer system, having a searchable database 22 and a keyword comparing module 24. The database 22 contains a large number of URLs.

The client 11 and the server 21 are connected through Internet. After the user inputs a keyword or keywords at the client 11, the client 11 transmits a request for search of the keyword or keywords to the server 21. After receipt of the request, the server 21 employs the keyword comparing module 24 to compare the information of the database 22 with the keyword or keywords in view of a first predetermined condition to further locate matched information in the database, ranks the matched information in view of a second predetermined condition to generate a list 41, ranks the list 41 in view of a third predetermined condition and then picks prior items ranked in the list 41 to generate a sub-list 45, and transmits the list 41 and the sub-list 45 to the client 11. After receipt of the list 41 and the sub-list 45, the client 11 displays them on the display device 12, wherein the sub-list 45 is located above the list 41.

As indicated above, the present invention allows the user to not only learn the result from the search web site after inputting the keyword but also get the relevant information to the keyword, enabling the user to source desired information more easily and improving the aforementioned drawback of the prior art.

Although the present invention has been described with respect to a specific preferred embodiment thereof, it is no way limited to the details of the illustrated structures but changes and modifications may be made within the scope of the appended claims.

What is claimed is:

1. A method of optimization of a listed result of internet-based search, comprising steps of:
(A) inputting a keyword on a web page capable of searching, wherein said web page is linked to a searchable database having information involved with a plurality of uniform resource locator s (URLs);
(B) comparing the information of said database with said keyword in view of a first predetermined condition and ranking matched information located in said database in view of a second predetermined condition to generate a list;
(C) ranking said list in view of a third predetermined condition and picking prior items ranked in said list to generate a sub-list; and
(D) displaying said list and said sub-list on a web page.

2. The method as defined in claim 1, wherein in the step (A), said web page comprises a search column for input of the keyword.

3. The method as defined in claim 2, wherein said search column is inputted through a keyboard of a computer system.

4. The method as defined in claim 1, wherein in the step (A), said searchable database further comprises a plurality of product names, a plurality of industry categories, and a plurality of classified links having product collective names; said URLs corresponds to said product names, said industry categories, and said classified links respectively.

5. The method as defined in claim 4, wherein said first predetermined condition comprises levels of similarity between characters of said keyword and those of said product names.

6. The method as defined in claim 4, wherein said second predetermined condition comprises levels of similarity of classified links for product collective names and product names on web sites, user click rates, amount of payment, or user's browsing duration.

7. The method as defined in claim 4, wherein said second predetermined condition comprises levels of similarity for classified links of collective product names, product names on web sites, product categories, and business categories, user click rates, amount of payment, or user's browsing duration.

8. The method as defined in claim 1, wherein in the step (D), said list and said sub-list are shown with text hyperlinks on a web page.

9. The method as defined in claim 1, wherein in the step (D), said sub-list is located above said list.

10. A system based on the method defined in claim 1, comprising:
a client defined as a computer system having an input device and a display device for a user's input and view; and
a server defined as a computer system having a searchable database and a keyword comparing module, said database having a plurality of URLs;
wherein said client and said server are connected through Internet; after the user inputs a keyword at said client, said client transmits a request for search said keyword to said server; after receipt of said request, said server employs said keyword comparing module to compare information of said database with said keyword in view of a first predetermined condition, ranks matched information located in said database in view of a second predetermined condition to generate a list, ranks said list in view of a third predetermined condition to pick prior items ranked in said list to generate a sub-list, and then transmits said list and said sub-list to said client, whereby said client displays said list and said sub-list on said display device.

11. The method as defined in claim 10, wherein said input device is a keyboard.

12. The method as defined in claim 10, wherein said sub-list is located above said list.
